(19) United States
(12) Patent Application Publication
(10) Pub. No.: US 2026/0208132 A1
(43) Pub. Date: Jul. 23, 2026

(54) LIQUEFACTION ENHANCEMENT DEVICE USING FLUID AGITATION, FOR INSTALLATION IN HEAT PUMP SYSTEM PIPING LINE

(71) Applicant: CPMH SG PTE. LTD., Singapore (SG)

(72) Inventor: Hajime ODANI, Tokyo (JP)

(73) Assignee: CPMH SG PTE. LTD., Singapore (SG)

(21) Appl. No.: 19/139,168

(22) PCT Filed: Nov. 10, 2023
(86) PCT No.: PCT/JP2023/040628

§ 371 Date: Jun. 13, 2025

(30) Foreign Application Priority Data
Dec. 13, 2022 (JP) 2022-198464

(51) Int. Cl. B01F 27/81; B01F 25/432; B01F 27/86; F25B 30/00

(52) U.S. Cl. CPC B01F 27/813; B01F 25/4322; B01F 27/861; F25B 30/00; F25B 2500/16; F25B 2500/18

(57) ABSTRACT

[Problem] The object is to reduce power consumption of a heat pump system by promoting even mixing of refrigerant and refrigerant oil.

[Solution] The stationary liquefaction enhancement device includes: a cylindrical inner tank; a flow-guiding unit installed inside the inner tank and made up of concentrically stacked large and small discs such that discs of the same diameter are adjacent each other; and an outer tank surrounding the inner tank. The device is installed in a piping line of a heat pump system to agitate fluids including refrigerant and refrigerant oil in a heat pump cycle of the heat pump system. The large-diameter discs and the small-diameter discs are staggered so that their respective cells positioned opposite each other communicate with each other. The fluids including refrigerant and refrigerant oil are passed through the stationary liquefaction enhancement device at pressures ranging from 0.2 to 10 megapascals during the operation of the heat pump system, and circulated repeatedly through the cycle of the heat pump system, thereby being agitated and mixed evenly.

### TECHNICAL FIELD

The present invention relates to a liquefaction enhancement device installed in a piping line of a heat pump system to promote fluid liquefaction by agitation. More particularly, the invention relates to a flow mixer that compresses fluid by passing it through slits or orifices, or a liquefaction enhancement device having rotary discs around a vertical shaft.

### BACKGROUND ART

Commercial heat pump systems that utilize a heat pump cycle, such as freezing cycle systems or air conditioning systems, tend to have extensive piping lines. The installation conditions of these systems vary widely. A heat pump system includes a compressor, a condenser, an expansion device, and an evaporator as main components. A refrigerant circulates through the piping that connects these components. Refrigerant oil is mixed with the refrigerant as the lubricating oil for the compressor. The compressor is provided with a refrigerant oil reservoir. The refrigerant oil, either mixed with or dissolved in the refrigerant, is discharged from the compressor, circulated with the refrigerant in the heat pump cycle, and returned to the compressor.

Chloride-containing CFCs and HCFCs having good miscibility with refrigerant oil were used as the refrigerant in the past. CFC substitute refrigerants, which have been used instead due to the problem of ozone layer destruction, are less miscible with refrigerant oil. The refrigerant oil discharged from the compressor separates more easily from the refrigerant and remains in equipment such as the condenser, or in the pipes, of the heat pump cycle. This can result in a lubricating oil shortage for the compressor. Insufficient lubrication could cause seizure in the compressor.

Refrigerant that is less miscible with refrigerant oil is less flowable itself. Moreover, the refrigerant oil that has remained in the equipment such as the condenser or in the pipes obstructs smooth flow of the refrigerant and the heat exchange in the condenser and the evaporator. This reduces the heat exchange efficiency of the heat pump system. In some cases, various additives such as chemical synthetic oils are added to refrigerant to ensure good miscibility with refrigerant oil. However, additives alone cannot provide sufficient solutions. Accordingly, various types of agitation means for dissolving refrigerant oil in refrigerant, or for mixing the oil evenly with the refrigerant, have been proposed.

Patent Literature 1 describes an agitation device inside a compressor for stirring the refrigerant and oil to prevent separation after discharge.

Another issue with the refrigerant in a heat pump cycle is that some of the refrigerant remains gaseous when it liquefies in the condenser. The remaining gaseous refrigerant is still there after passing through the expansion device, so that the refrigerant at the entrance of the evaporator is in the gas-liquid phase. The remaining gaseous refrigerant does not contribute to the heat transfer in the evaporator and causes a reduction in the heat exchange rate.

Patent Literatures 2 and 3 propose a gas-liquid separator that is installed downstream of the expansion device. The gas-liquid separator separates the refrigerant in the gas-liquid phase into gas and liquid, sending liquid refrigerant alone to the evaporator and returning the gaseous refrigerant to the compressor.

Patent Literature 4 discloses a different technique: a bubble removal device that eliminates residual bubbles that are generated by radicals during the condensation of the refrigerant in the condenser, in order to ensure complete liquefaction of the refrigerant. This device includes a cylindrical vessel and installed on the exit side of the condenser (outdoor unit) in cooling mode. The cylindrical vessel stirs the refrigerant by creating a helical swirling flow inside to remove bubbles.

Other examples of agitation devices include those described in Patent Literature 5, Patent Literature 6, and Patent Literature 7, which are not directly related to a heat pump. These are a device that stirs (mixes) a high-pressure fluid by passing it through a stack of discs with an array of numerous polygonal cells, housed in a cylindrical casing. This device does not include a rotating part such as a motor.

### CITATION LIST

### Patent Literature

Patent Literature 1: Patent Publication JP-A-2008-163782
Patent Literature 2: Patent Publication JP-A-H6-109345
Patent Literature 3: Patent Publication JP-A-2008-75894
Patent Literature 4: WO 2013/099972
Patent Literature 5: Japanese Examined Patent Publication No. S59-39173
Patent Literature 6: Patent Publication JP-A-H11-9980
Patent Literature 7: Patent Publication JP-A-H11-114396

### SUMMARY OF INVENTION

### Technical Problem

An agitation means provided inside the compressor as described in Patent Literature 1 cannot solve the first issue mentioned above of poor miscibility between refrigerant and refrigerant oil because the agitation means alone cannot completely prevent the refrigerant oil from remaining in each of the components along the extensive piping of the heat pump cycle. In the condenser, in particular, the refrigerant oil droplets merge as the temperature drops, increasing the oil phase, which causes the liquid refrigerant to be easily trapped in the oil. The liquid refrigerant entrapped in the refrigerant oil cannot contribute to the heat transfer. This tendency increases when the external temperature is low.

Regarding the second issue mentioned above, where some of the refrigerant remains gaseous as it liquefies in the condenser, gas-liquid separators, such as those in Patent Literatures 2 and 3, are effective only to some extent in cooling mode and are hardly effective in heating mode. Known gas-liquid separators are incorporated in a system and lack versatility, because they cannot be retrofitted to an existing system. To enhance the heat exchange efficiency of an existing heat pump system for energy saving, an agitation means that can be easily attached to an existing heat pump system is required.

Freezers and air conditioners, which are concrete forms of heat pump systems, come in a wide variety of types. A versatile fluid agitation device that can be attached to any of these existing heat pump systems is desirable.

The agitation efficiency of agitation devices that use a helical swirling flow such as the one in Patent Literature 4 is insufficient. In the first place, Patent Literature 4 is directed to the removal of a special type of bubbles generated by radicals. Meanwhile, most of the air bubbles remaining in the refrigerant after it has liquefied in the condenser are formed by some of the refrigerant remaining gaseous as a result of passing straight through the condenser and failing to be cooled equal to or lower than the condensation temperature.

Through experiments, the inventors of the present invention discovered that it is not possible to liquefy gaseous refrigerant at a temperature equal to or higher than the condensation temperature using the agitation device of Patent Literature 4, which creates swirling flows within a substantially horizontal plane.

In view of the circumstances described above, an object of the present invention is to provide a liquefaction enhancement device that ensures dissolution or even mixing of refrigerant oil in refrigerant, and enhances liquefaction of gaseous refrigerant, by efficient agitation of fluids in a heat pump system, thereby improving the heat exchange efficiency and reducing energy consumption of the heat pump system.

### Solution to Problem

To achieve the above object, the present invention provides the following configurations.

Through testing various types of agitation (mixing) devices, the inventors discovered that the agitation devices shown in Patent Literature 5, Patent Literature 6, and Patent Literature 7 could be used effectively as a liquefaction enhancement device that uses agitation (mixing), for installation in a heat pump system midway through one of the piping lines.

Namely, the liquefaction enhancement device that uses fluid agitation according to the present invention is a stationary liquefaction enhancement device, including: a cylindrical inner tank including an inner-tank outlet at one end and an inner-tank inlet at the other, and a side wall formed with a plurality of apertures; a flow-guiding unit installed inside the inner tank, including concentrically stacked large-diameter discs and small-diameter discs each formed with a honeycomb-like array of numerous open polygonal cells on one side facing each other, the large-diameter discs being adjacent each other and the small-diameter discs being adjacent each other; an outer tank surrounding the cylindrical inner tank; an outer-tank inlet of the outer tank; and an outer-tank outlet of the outer tank, the stationary liquefaction enhancement device being installed in a line of piping of a heat pump system by connecting the outer-tank inlet and the outer-tank outlet to the piping for agitating fluids including a refrigerant and a refrigerant oil in a cycle of the heat pump system, the large-diameter discs having a diameter matching an inside diameter of the inner tank and formed with a communication hole in a center area,
the large-diameter discs and the small-diameter discs being staggered such that their respective cells positioned opposite each other communicate with each other, the large-diameter discs of the flow-guiding unit being positioned at both ends of the cylindrical inner tank, with the communication holes being communicated with the inner-tank outlet and the inner-tank inlet, the fluids including the refrigerant and the refrigerant oil being passed through both the inner tank and the outer tank of the stationary liquefaction enhancement device at pressures ranging from 0.2 to 10 megapascals during an operation of the heat pump system, and circulated repeatedly through the cycle of the heat pump system, thereby being agitated and mixed evenly.

The refrigerant and refrigerant oil in the heat pump system are thereby mixed evenly in an optimal manner, which helps reduce power consumption.

The liquefaction enhancement device according to the present invention is a rotary liquefaction enhancement device including: an agitation tank including an agitation-tank outlet, an agitation-tank inlet, and a side wall formed with a plurality of apertures; a rotation shaft provided inside the agitation tank; a rotary drive source configured to rotate the rotation shaft; a rotary mixing member attached to the rotation shaft and configured to agitate fluids inside the agitation tank; an outer tank surrounding the agitation tank; an outer-tank inlet of the outer tank; and an outer-tank outlet of the outer tank, the rotary liquefaction enhancement device being installed in a line of piping of a heat pump system by connecting the outer-tank inlet and the outer-tank outlet to the piping for agitating fluids including a refrigerant and a refrigerant oil in a cycle of the heat pump system to enhance liquefaction, the rotary mixing member including a pair of an upper disc and a lower disc stacked upon one another, the lower disc having an inlet port in a center area, the upper disc and the lower disc each being formed with an array of numerous tubular cells on their front side facing each other and open toward each other, the cells of the upper disc and the cells of the lower disc opposite each other communicating with other, the arrays of cells being offset so that an intersecting joint portion of a side wall that forms a cell of one disc is located at the center of a cell of the other disc, the fluids including the refrigerant and the refrigerant oil being passed through both the agitation tank and the outer tank of the rotary liquefaction enhancement device at pressures ranging from 0.2 to 10 megapascals during an operation of the heat pump system, and circulated repeatedly through the cycle of the heat pump system, thereby being agitated and mixed evenly.

The refrigerant and refrigerant oil in the heat pump system are thereby mixed evenly in an optimal manner, which helps reduce power consumption.

The device further features a spring provided inside the outer tank; the spring has a smaller outer shape than the inside diameter of the outer tank so as to allow its free vibration.

This suppresses pulsing fluctuations and further enhances the shear effects.

The device further features a spring provided inside the agitation tank; the spring has a smaller outer shape than the inside diameter of the agitation tank so as to allow its free vibration.

This suppresses pulsing fluctuations and further enhances the shear effects.

The device further features a spring provided inside the outer tank; the spring has a smaller outer shape than the inside diameter of the outer tank so as to allow its free vibration.

This suppresses pulsing fluctuations and further enhances the shear effects.

### Advantageous Effects of Invention

The liquefaction enhancement device that uses fluid agitation according to the present invention provides advantageous effects of mixing the refrigerant and refrigerant oil in a heat pump system evenly in an optimal manner, thereby improving the heat exchange efficiency and reducing energy consumption.

### BRIEF DESCRIPTION OF DRAWINGS

FIG. 1 is a diagram illustrating an example of a stationary liquefaction enhancement device applied to a heat pump system. FIG. 1(a) illustrates the fluid flow directions in cooling mode. FIG. 1(b) illustrates the fluid flow directions in heating mode.

FIG. 2 is a diagram illustrating a cell structure in detail. FIG. 2(a) is a diagram viewed from the fluid entrance side. FIG. 2(b) is an A-A cross section.

FIG. 3 is a diagram illustrating shape variations of the cell. FIG. 3(a) shows a pattern of repeated regular octagons. FIG. 3(b) shows a pattern of repeated regular hexagons. FIG. 3(c) shows a pattern of repeated regular triangles. FIG. 3(d) shows a pattern of repeated squares.

FIG. 4 is a partially enlarged view of a flow-guiding unit, depicting a detailed configuration including large-diameter discs, small-diameter discs, and cells.

FIG. 5 is a perspective view illustrating an example of the small-diameter disc.

FIG. 6 is a diagram illustrating an example of a stationary liquefaction enhancement device equipped with an outer tank and applied to a heat pump system. FIG. 6(a) illustrates the fluid flow directions in cooling mode. FIG. 6(b) illustrates the fluid flow directions in heating mode.

FIG. 7 is a diagram illustrating the configuration of a heat pump system with a rotary liquefaction enhancement device installed in a piping line. FIG. 7(a) illustrates the fluid flow directions in cooling mode. FIG. 7(b) illustrates the fluid flow directions in heating mode.

FIG. 8 is a diagram illustrating the two discs that make up a rotary mixing member, the shape of the cells, and how the discs are assembled.

FIG. 9 is a diagram illustrating the detailed configuration of the rotary mixing member and the fluid flows.

FIG. 10 is a diagram illustrating shape variations of the cell. FIG. 10(a) shows a pattern of repeated regular triangles. FIG. 10(b) shows a pattern of repeated squares. FIG. 10(c) shows a pattern of repeated regular octagons. FIG. 10(d) shows a pattern of repeated regular hexagons.

FIG. 11 is a diagram illustrating an example of a rotary liquefaction enhancement device equipped with an outer tank and applied to a heat pump system. FIG. 11(a) illustrates the fluid flow directions in cooling mode. FIG. 11(b) illustrates the fluid flow directions in heating mode.

FIG. 12 is a diagram illustrating a configuration example of a set of three stacked rotary mixing members.

FIG. 13 is a cross-sectional view illustrating the structure of a liquefaction enhancement device with a spring.

FIG. 14 is a cross-sectional view illustrating an example of a stationary liquefaction enhancement device with a spring applied therein.

FIG. 15 is a cross-sectional view illustrating an example of a stationary liquefaction enhancement device with a spring applied therein, and equipped with an outer tank.

FIG. 16 is a cross-sectional view illustrating an example of a stationary liquefaction enhancement device with an outer tank, in which a spring is applied to the outer tank.

FIG. 17 is a cross-sectional view illustrating an example of a rotary liquefaction enhancement device with a spring applied therein.

FIG. 18 is a cross-sectional view illustrating an example of a rotary liquefaction enhancement device with a spring applied therein, and equipped with an outer tank.

FIG. 19 is a cross-sectional view illustrating an example of a rotary liquefaction enhancement device with an outer tank, in which a spring is applied to the outer tank.

FIG. 20 is a table showing the power reduction performance of liquefaction enhancement devices.

FIG. 21 is a diagram of a liquefaction enhancement device in which valves are provided in piping parts, to enable its shipment in a ready-to-use state for individual heat pump systems, already filled with the necessary amount of refrigerant.

### DESCRIPTION OF EMBODIMENTS

Hereinafter, embodiments of the device according to the present invention will be described with reference to the drawings. The same reference numerals are used to describe configurations that are the same or similar.

### Embodiment of Stationary Liquefaction Enhancement Device With Only Inner Tank and Without Outer Tank

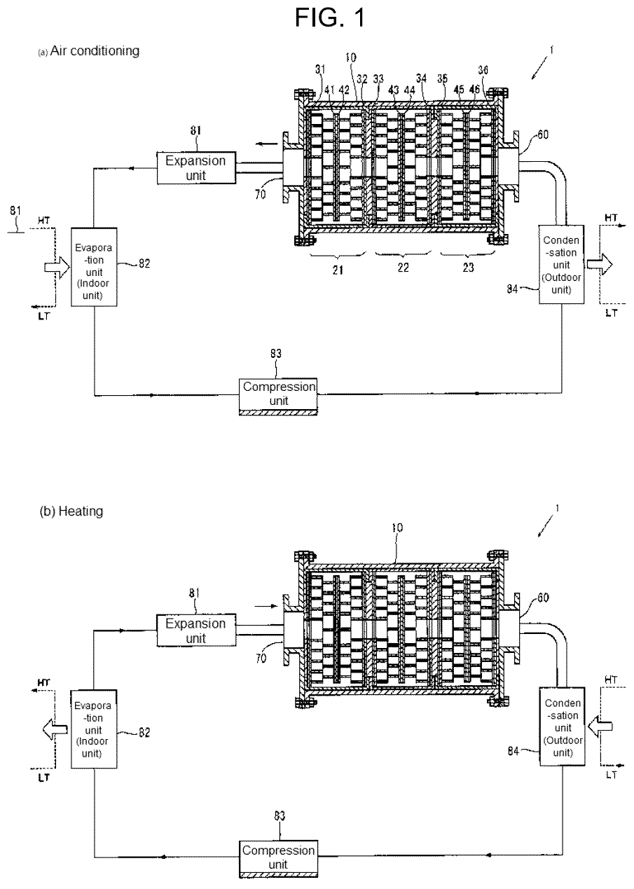

Configuration FIG. 1 to FIG. 5 illustrate Embodiment 1 of the present invention. FIG. 1 is a diagram illustrating an example in which the stationary liquefaction enhancement device 1 is applied to a heat pump system. Heat pump systems come in various forms, including air conditioners, freezers, refrigerators, boilers, freezer warehouses, chillers, and so on. The invention is also applicable to systems that use other energies than electricity, such as gas heat pumps. The device according to the invention can be incorporated into a newly designed heat pump system, or can be retrofitted into an existing heat pump system.

A heat pump system takes heat away from a low-temperature object and transfers it to a high-temperature object. It is used for the purpose of further cooling a low-temperature object or further heating a high-temperature object. Devices that switchably cool and heat air are also a type of a heat pump.

The term “fluid” as used herein refers to fluids that circulate through a heat pump cycle, including refrigerant and refrigerant oil. The fluids take one of the gaseous, liquid, or gas-liquid mixed states depending on which process they are in during the heat pump cycle.

FIG. 1 illustrates schematics of a heat pump cycle of a common air conditioner as one example. The figure shows the interior of the device according to the present invention in cross section. FIG. 1(a) illustrates the fluid flow directions in cooling mode. FIG. 1(b) illustrates the fluid flow directions in heating mode.

In cooling mode, the heat pump cycle includes four components: a compression unit 83, condensation unit (outdoor unit 84), expansion unit 81, and an evaporation unit (indoor unit 82). Fluids circulate through the sealed piping that connects these components. The arrows in FIG. 1(a) and FIG. 1(b) show the fluid flow directions. The white arrows indicate the heat transfer in the condensation unit (outdoor unit 84 in cooling mode, and indoor unit 82 in heating mode) and in the evaporation unit (indoor unit 82 in cooling mode, and outdoor unit 84 in heating mode). The broken line arrows indicate the heat transfer across indoor and outdoor. Symbols LT and HT represent low temperature and high temperature, respectively.

The compression unit 83 in the room-cooling cycle in FIG. 1(a) includes a compressor inside a sealed vessel for compressing a low-pressure gaseous refrigerant. Typically, the sealed vessel that houses the compressor includes an oil reservoir for storing refrigerant oil (the bottom part of the drawing). The gaseous refrigerant is compressed to a high-pressure and high-temperature gas. After mixed with the refrigerant oil, the gaseous refrigerant is discharged from the compression unit 83 to the condensation unit (outdoor unit 84). The condensation unit includes a condenser. In cooling mode, the outdoor unit 84 performs heat exchange as the condensation unit. The high-temperature, high-pressure gaseous fluid that flows into the condensation unit releases heat to the outside space to condense into a low-temperature liquid-phase fluid. This liquid-phase fluid should ideally be the refrigerant in liquid form in which the refrigerant oil is dissolved (or evenly mixed).

However, some of the refrigerant oil may sometimes fail to dissolve in (or mix evenly with) the refrigerant and separate from the refrigerant as it transforms from gas into liquid in the condensation unit (outdoor unit 84). The liquid refrigerant may also become entrapped in the oil phase of the merged refrigerant oil droplets. Moreover, some of the refrigerant may pass straight through the condensation unit (outdoor unit 84) and remain as a high-temperature gas. Due to these phenomena, there is the possibility that the liquid-phase fluid flowing out of the condensation unit (outdoor unit 84) may contain separated refrigerant oil, refrigerant trapped in the oil phase of the refrigerant oil, and/or gaseous refrigerant.

The liquefaction enhancement device 1 of the present invention is interposed between the components that act as the condensation unit (outdoor unit 84) and the expansion unit 81 in the room-cooling mode shown in FIG. 1(a). The inlet 60 of the liquefaction enhancement device 1 is connected to the exit side of the condensation unit or the outdoor unit 84. The outlet 70 of the liquefaction enhancement device 1 is connected to the entrance side of the expansion unit 81. The fluids flowing out of the condensation unit 84 are mixed well due to the shear effects sufficiently provided inside the liquefaction enhancement device 1. This allows the separated refrigerant oil to mix evenly with the liquid refrigerant and releases the liquid refrigerant trapped in the oil phase. As the temperature drops, any remaining gaseous refrigerant turns into liquid refrigerant. The fluids flowing out of the liquefaction enhancement device 1 are then sent to the expansion unit 81.

The expansion unit 81 includes an expansion valve or capillary tubes. The low-temperature, high-pressure liquid-phase fluid becomes a low-pressure and low-temperature liquid as it flows through fine apertures or tubes. After that, this fluid is sent to the evaporation unit (indoor unit 82). The evaporation unit includes an evaporator. In the room-cooling mode shown in FIG. 1(a), the indoor unit 82 performs heat exchange as the evaporation unit. The low-temperature, low-pressure liquid-phase fluid that flows into the evaporation unit absorbs heat from the outside space to evaporate into a high-temperature gaseous fluid. Thus the air in the room is cooled. After that, the gaseous fluid is returned to the compression unit 83.

In the room-heating cycle shown in FIG. 1(b), the circulation direction of fluids is reverse from that of the cooling mode shown in FIG. 1(a). A known valve (illustration and description omitted) is used to switch the circulation direction of the fluids in the heat pump system. In heating mode, the high-temperature, high-pressure gaseous fluid discharged from the compression unit 83 is sent to the indoor unit 82 that performs heat exchange as the condensation unit. The high-temperature, high-pressure gaseous fluid that flows into the condensation unit (indoor unit 82) releases heat to the outside space to condense into a low-temperature liquid-phase fluid. Thus the air in the room is heated.

There is the possibility, similarly to the cooling cycle shown in FIG. 1(a), that the refrigerant changing from gas to liquid in the condensation unit (indoor unit 82) and flowing out may contain separated refrigerant oil, liquid refrigerant trapped in the oil phase of the refrigerant oil, and/or gaseous refrigerant. In heating mode, the liquid-phase fluid flowing out of the condensation unit (indoor unit 82) is sent further to the expansion unit 81, where it turns into a low-pressure, low-temperature liquid. Even after the liquid has passed through the expansion unit 81, it may still contain the separated refrigerant oil, trapped liquid refrigerant, and/or gaseous refrigerant.

The liquefaction enhancement device 1 of the present invention is interposed between the components that act as the expansion unit 81 and the evaporation unit (outdoor unit 84) in the room-heating mode shown in FIG. 1(b). The inlet 70 of the liquefaction enhancement device 1 is connected to the exit side of the expansion unit 81. The outlet 60 of the liquefaction enhancement device 1 is connected to the entrance side of the evaporation unit or the outdoor unit 84. The fluids flowing out of the expansion unit 81 are mixed thoroughly and evenly inside the liquefaction enhancement device 1. This allows the separated refrigerant oil to mix evenly with the liquid refrigerant and releases the liquid refrigerant trapped in the oil phase. Any remaining gaseous refrigerant turns into liquid refrigerant as the temperature drops. The fluids flowing out of the liquefaction enhancement device 1 are then sent to the evaporation unit (outdoor unit 84).

In the room-heating mode shown in FIG. 1(b), the outdoor unit 84 performs heat exchange as the evaporation unit. The low-temperature, low-pressure liquid-phase fluid that flows into the evaporation unit absorbs heat from the outside space to evaporate into a high-temperature gaseous fluid. After that, the gaseous fluid is returned to the compression unit 83.

As shown in FIG. 1(a) and FIG. 1(b), the liquefaction enhancement device 1 of the present invention is added to a piping line of a heat pump system. The actual piping is formed by connecting several pipe members together. The liquefaction enhancement device 1 can easily be installed by removing one of these pipe members, for example, and replacing it with the liquefaction enhancement device 1 of the present invention. As shown in FIG. 1(a) and FIG. 1(b), the device may be installed in an outdoor part of the piping near the outdoor unit, for example. The piping in this part is designed to form a smooth, appropriately sized curve to allow smooth flow of the fluids inside.

As described above, FIG. 1(a) and FIG. 1(b) illustrate an example of the liquefaction enhancement device 1 of the present invention applied to a basic heat pump system. There are many applied forms of actual heat pump systems. The liquefaction enhancement device 1 of the present invention is also applicable to other systems that include various components added to the basic heat pump system. For example, the liquefaction enhancement device 1 of the present invention can be combined with a system that includes a gas-liquid separator to separate refrigerant in a gas-liquid two-phase state.

The liquefaction enhancement device 1 of the present invention can also be combined with a system that includes an ejector and a gas-liquid separator in place of the expansion unit, for example.

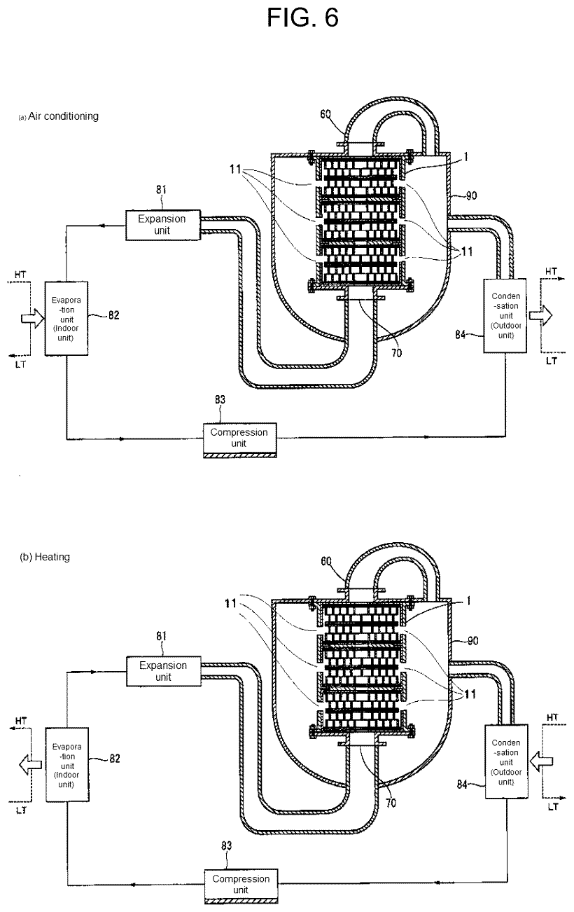

The term “stationary” as in “the stationary liquefaction enhancement device 1 shown in FIG. 1” means that the discs are fixed and do not rotate or move. The casing 10, which is cylindrical, is fixed. The cylindrical casing 10 is configured as a highly airtight pressure vessel that allows a gas-liquid mixture with a pressure of approximately 10 megapascals to flow through. In this regard, the casing differs from the side walls of the inner tank in the embodiments to be described later with reference to FIG. 6 and onwards.

The cylindrical casing 10 further includes large-diameter discs 31, 32, 33, 34, 35, and 36 inside. These discs are fixed and are not movable. An elastic member is disposed between the cylindrical casing 10 and the large-diameter discs so that fluids cannot pass through. A communication hole is formed in a center part of the large-diameter discs 31, 32, 33, 34, 35, and 36 to allow fluids to pass through. Small-diameter discs 41, 42, 43, 44, 45, and 46 are provided with a clearance from the cylindrical casing 10. Fluids can pass through the clearance between the small-diameter discs and the cylindrical casing 10. There is no communication hole in the center part of the small-diameter disc 41, 42, 43, 44, 45, and 46.

Inside the cylindrical casing 10, flow-guiding units 21, 22, and 23 are concentrically stacked upon one another. Inside the flow-guiding unit 21 are arranged the large-diameter disc 31, cell arrays, small-diameter disc 42, cell arrays, and large-diameter disc 32. The other flow-guiding units have the same configuration. Therefore, the fluids entering from the cooling-mode inlet 60 travel through the communication hole in the large-diameter disc, the cells, the clearance between the edge of the small-diameter disc and the casing, the cells, and the communication hole in the large-diameter disc, repeating the sequence three times before exiting from the cooling-mode outlet 70. The fluids are mixed evenly by the shear effects in this process.

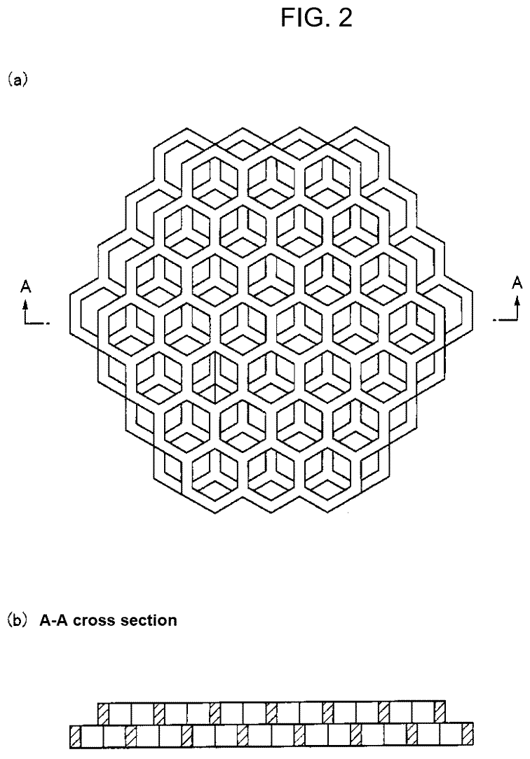

FIG. 2 is a diagram illustrating the cell structure in detail. FIG. 2(a) is a diagram viewed from the fluid entrance side. FIG. 2(b) is an A-A cross section. The drawing shows only the cells, without the large-diameter discs and small-diameter discs. As shown in FIG. 2, two layers of polygons (here, regular hexagons) tightly aligned in a honeycomb-like pattern are stacked with a displacement. This configuration increases the fluid path complexity to achieve higher shear effects.

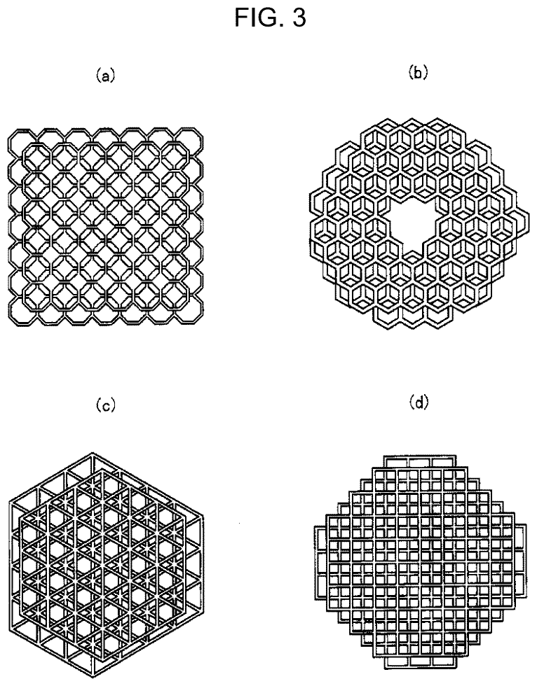

FIG. 3 is a diagram illustrating shape variations of the cells. FIG. 3(a) shows a pattern of repeated regular octagons. FIG. 3(b) shows a pattern of repeated regular hexagons. FIG. 3(c) shows a pattern of repeated regular triangles. FIG. 3(d) shows a pattern of repeated squares. The term “honeycomb-like,” used earlier, is intended in a broader sense to describe any extensive, two-dimensional pattern of tightly packed, repeated polygonal shapes that are not necessarily hexagons. Thus the shapes such as regular octagon, regular hexagon, regular triangle, and square as shown in FIG. 3 are also included. In any case, the two extensive layers of cells are stacked upon one another with a relative displacement. In other words, the cells on the large-diameter disc and the cells on the small-diameter disc are arranged so that they can communicate with each other. The honeycomb-like patterns of repeated shapes offset from each other as shown in FIG. 3 make the fluid path more complex.

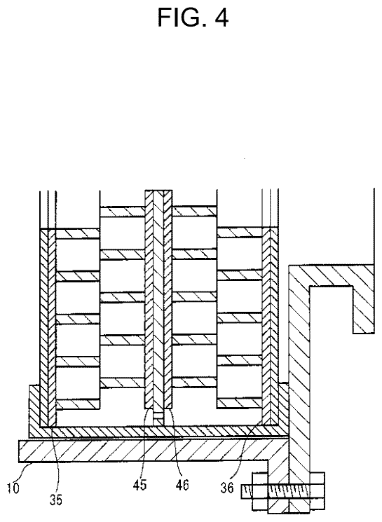

FIG. 4 is a partially enlarged view of one of the flow-guiding units, depicting the detailed configuration near the cylindrical casing 10, including the large-diameter discs 35 and 36, small-diameter discs 45 and 46, and cells. As shown in FIG. 4, a hole is formed in a portion on the outer side of the small-diameter discs 45 and 46 near the inner wall of the cylindrical casing 10, to allow the fluids to pass through.

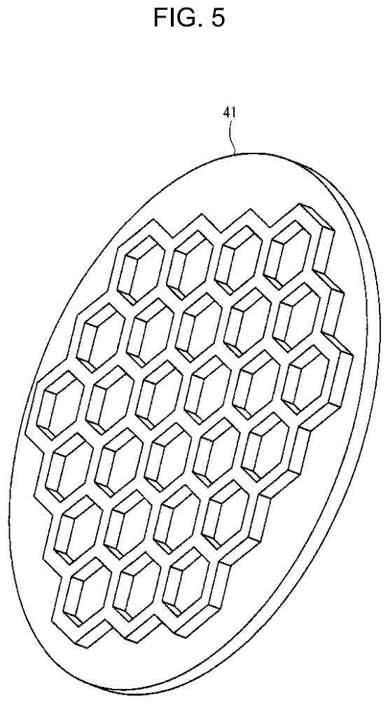

FIG. 5 is a perspective view illustrating an example of the small-diameter disc 41. As shown in FIG. 5, the small-diameter disc 41 includes honeycomb-like cells bonded thereto, and is set opposite the large-diameter disc.

### Operation

The liquefaction enhancement device 1 evenly mixes fluids including refrigerant and refrigerant oil using the shear effects achieved by passing the fluids at pressures ranging from 0.2 to 10 megapascals. The device can thus improve the heat exchange efficiency of CFC substitutes.

While the liquefaction enhancement device 1 in FIG. 1 uses the cylindrical casing in a horizontal orientation, the device can operate similarly with the casing oriented upright.

### Embodiment of Stationary Liquefaction Enhancement Device With Outer Tank

FIG. 6 is a diagram illustrating an example of the stationary liquefaction enhancement device 1 equipped with an outer tank and applied to a heat pump system. FIG. 6(a) illustrates the fluid flow directions in cooling mode. FIG. 6(b) illustrates the fluid flow directions in heating mode.

The outer tank 90 is configured as a sealed vessel or an airtight vessel that covers the cylindrical casing 10. It is configured as a pressure vessel that can withstand 10 megapascals of pressure. The fluids flowing in from the outdoor unit 84 in cooling mode are temporarily accumulated in the outer tank 90, making contact with the outer side walls of the cylindrical casing 10. After that, fluids enter the stationary liquefaction enhancement device 1, some from the inlet 60 and some through a plurality of apertures 11 formed in the side walls of the cylindrical casing 10. The fluids then exit from the outlet 70 and flow to the expansion unit 81. The plurality of apertures are provided in the side walls of the cylindrical casing 10 for the purpose of regulating the fluid pressure within an appropriate range. The size, number, and spacing of the apertures can be determined in consideration of the trade-off relationship between the pressure-regulating effects and the liquefaction-enhancing effects. Without the apertures, an excessive pressure on the pipe that transfers the fluids from the outer tank to the stationary liquefaction enhancement device 1 may cause a malfunction. The casing 10 having apertures in its side walls means that there is no need for the casing 10 to be configured as a pressure vessel. Designing the casing 10 without the need to provide airtightness can lead to cost

In heating mode, the fluids travel in the reverse route as shown in FIG. 6(b), i.e., some of the fluids exiting from the outlet 60 is accumulated in the outer tank 90 before traveling to the outdoor unit 84. The rest of the fluids flows through the outer tank 90 toward the outdoor unit 84 via the apertures in the side walls of the casing 10.

The outer tank 90 prevents potentially excessive fluid pressure from being applied to the casing 10 while efficiently guiding the fluid flow.

### Embodiment of Rotary Liquefaction Enhancement Device With Only Inner Casing and Without Outer Tank

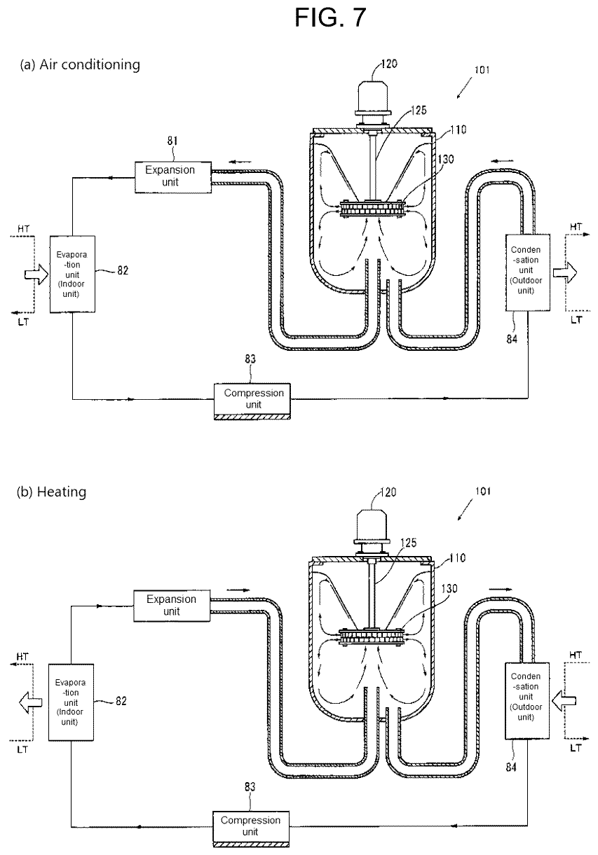

FIG. 7 is a diagram illustrating the configuration of a heat pump system with a rotary liquefaction enhancement device 101 installed in a piping line. FIG. 7(a) illustrates the fluid flow directions in cooling mode. FIG. 7(b) illustrates the fluid flow directions in heating mode.

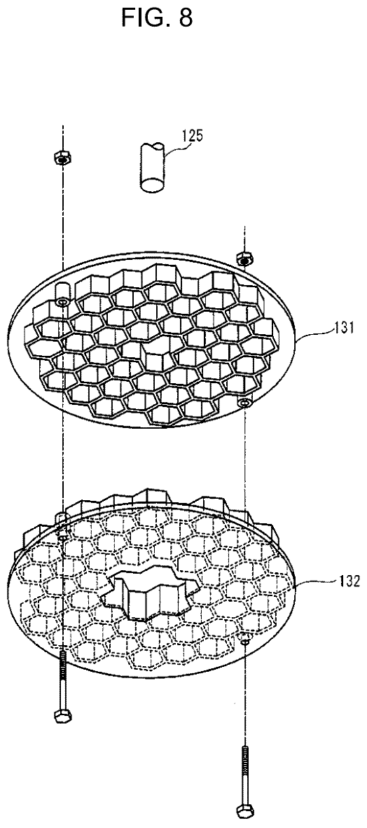

The rotary liquefaction enhancement device 101 in this embodiment includes an agitation tank 110. A rotary mixing member 130, attached to a rotation shaft 125 that is coupled to a rotary drive source (motor) 120, is rotated to mix the fluids evenly in the agitation tank 110. The rotary mixing member 130, as will be described with reference to FIG. 8 to FIG. 10, is configured with multiple honeycomb-like cells.

FIG. 8 is a diagram illustrating the two discs 131 and 132 that make up the rotary mixing member 130, the shape of the cells, and how the discs are assembled. Both the upper disc 131 and the lower disc 132 include multiple honeycomb-like cells. The two discs are assembled with their open cell sides facing each other.

The discs are stacked such that the honeycomb-like cells are offset from each other. The two discs 131 and 132 are designed to attach to the rotation shaft 125, and include a communication hole in their center area to allow the fluids to pass through.

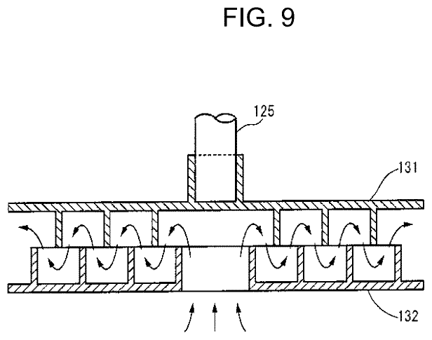

FIG. 9 is a cross-sectional view illustrating the detailed configuration of the rotary mixing member 130 and the fluid flows. As shown in FIG. 9, fluids drawn in from below the center of the rotary mixing member travel toward the periphery, passing through numerous cells along the way. The fluids are mixed evenly due to the shear effects during this process. The fluids inside the agitation tank 110 exit after being mixed well and evenly.

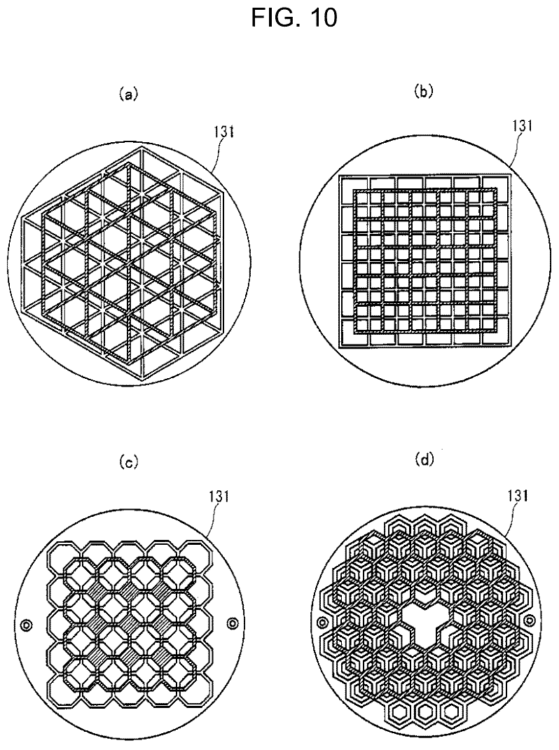

FIG. 10 is a diagram illustrating shape variations of the cell. FIG. 10(a) shows a pattern of repeated regular triangles. FIG. 10(b) shows a pattern of repeated squares. FIG. 10(c) shows a pattern of repeated regular octagons. FIG. 10(d) shows a pattern of repeated regular hexagons.

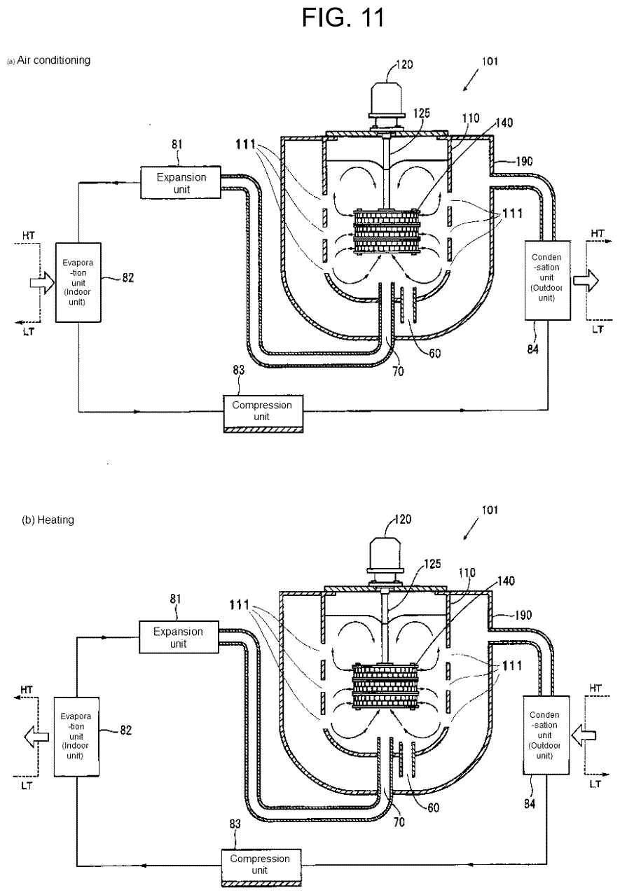

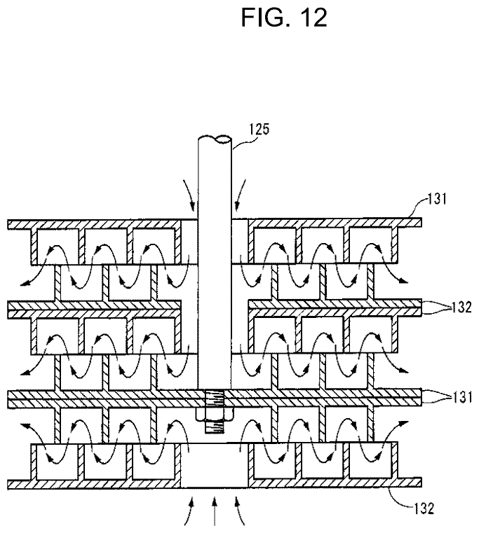

A set of three rotary mixing members stacked upon one another may be used, as shown in FIG. 11 and FIG. 12.

### Embodiment of Rotary Liquefaction Enhancement Device With Outer Tank

FIG. 11 is a diagram illustrating an example of a rotary liquefaction enhancement device 101 equipped with an outer tank 190 and applied to a heat pump system. FIG. 11(a) illustrates the fluid flow directions in cooling mode. FIG. 11(b) illustrates the fluid flow directions in heating mode. This embodiment adopts the rotary liquefaction enhancement device 101 instead of the stationary liquefaction enhancement device shown in FIG. 6. The device operates similarly and provides similar effects.

In FIG. 6, a plurality of apertures 11 are provided in the side walls of the cylindrical casing. Similarly, in FIG. 11, a plurality of apertures 111 are provided in the side walls of the agitation tank 110, which is the vessel for the rotary liquefaction enhancement device 101. Thus the fluid pressure can be regulated to an appropriate range. The agitation tank 110 does not require high pressure resistance and can be designed without airtightness.

FIG. 12 is a diagram illustrating an example configuration of a set of three stacked rotary mixing members. In this example of three stacked rotary mixing members, the fluids are drawn in not only from below but also from above. The fluids are transferred to the periphery of the discs 131 and 132 through numerous cells, and mixed evenly due to the shear effects along the way.

### Embodiment Using Spring

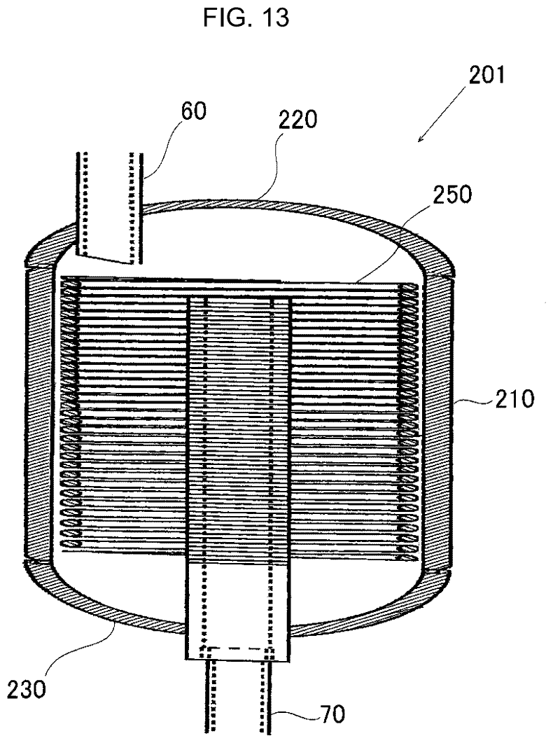

FIG. 13 is a cross-sectional view illustrating an example of a liquefaction enhancement device 201 that uses a spring, as one alternative to the stationary liquefaction enhancement device 1. The liquefaction enhancement device 201 depicted in FIG. 13 does not include the above-described flow-guiding units made up of honeycomb-like cells. Instead, the device has a spring 250 in the cylindrical casing 210. The spring 250 is a helical spring (coil spring), with an outside diameter that is smaller than the inside diameter of the cylindrical casing 210. The size of the spring 250 is adjusted so that there is a clearance (e.g., 0.1 mm to 5 mm) between the spring 250 and the inner wall of the cylindrical casing 210. The clearance allows free vibration of the spring 250.

An upper casing 220 and a lower casing 230 are provided on the top and bottom of the cylindrical casing 210, respectively, forming a hermetically sealed space. This sealed space is strong enough to allow fluids to flow at high pressures of 10 megapascals. The inlet 60 is provided to the upper casing 220. The outlet 70 is provided to the lower casing 230. The inlet 60 and the outlet 70 are located at offset positions to prevent incoming fluids from flowing straight out.

### Operation

Fluids including refrigerant and refrigerant oil are passed through the liquefaction enhancement device 201 at pressures ranging from 0.2 to 10 megapascals. The spring 250 vibrates freely in all directions within the liquefaction enhancement device 201 to suppress pulsation of the high-pressure fluids (pulsing pressure fluctuations), thus stabilizing the pressure. The freely vibrating spring 250 hits the fluids in various directions and mixes the refrigerant and refrigerant oil evenly by the shear effects. The device can thus improve the heat exchange efficiency of CFC substitutes. The effects are enhanced as the fluids circulate through the piping line of the heat pump system repeatedly.

### Embodiment of Stationary Liquefaction Enhancement Device With Spring

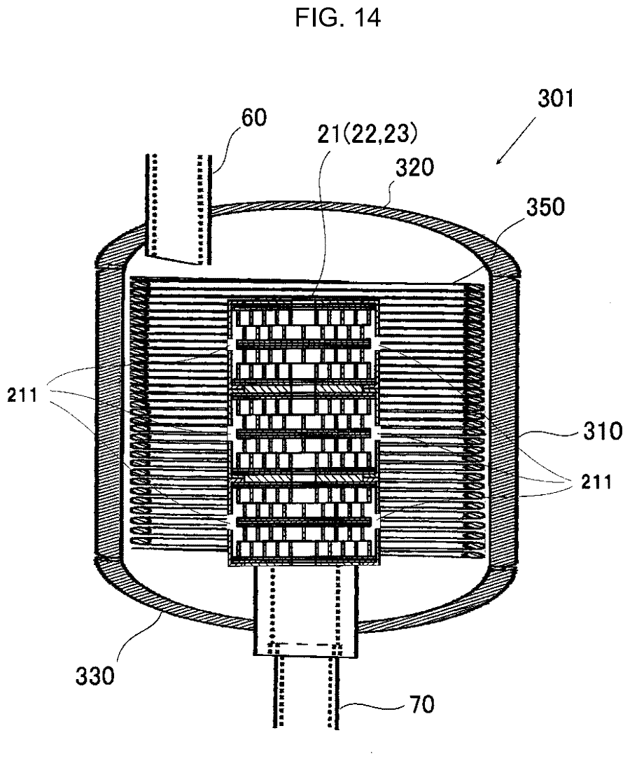

FIG. 14 is a cross-sectional view illustrating an example of a liquefaction enhancement device 301, or the stationary liquefaction enhancement device 1 having the stationary flow-guiding units made up of honeycomb-like cells, as well as a spring. The liquefaction enhancement device 301 depicted in FIG. 14 includes both the flow-guiding units 21, 22, and 23 made up of honeycomb-like cells and a spring 350. The size of the spring 350 is adjusted so that there is a clearance between the spring 350 and the inner wall of the casing 310 to allow free vibration of the spring 350, similarly to the liquefaction enhancement device 201.

Similarly to the liquefaction enhancement device 201, the upper casing 320 and the lower casing 330 together form a sealed space, which is strong enough to allow fluids to flow at high pressures of 10 megapascals. The inlet 60 and the outlet 70 are located at offset positions to prevent incoming fluids from flowing straight out.

In this embodiment, too, a plurality of apertures 211 can be provided in the side walls of the cylindrical casing that encases the flow-guiding units 21, 22, and 23 to regulate the fluid pressure within an appropriate range.

### Operation

The spring 350 in the liquefaction enhancement device 301 provides both pulsation suppression and the shear effects, similarly to the liquefaction enhancement device 201. The flow-guiding units 21, 22, and 23 further provide the shear effects. Therefore, the spring 350 and the flow-guiding units 21, 22, and 23 act synergistically to mix the refrigerant and refrigerant oil evenly. The device can thus improve the heat exchange efficiency of CFC substitutes. The effects are enhanced as the fluids circulate through the piping line of the heat pump system repeatedly.

### Embodiment of Stationary Liquefaction Enhancement Device With Spring and Outer Tank

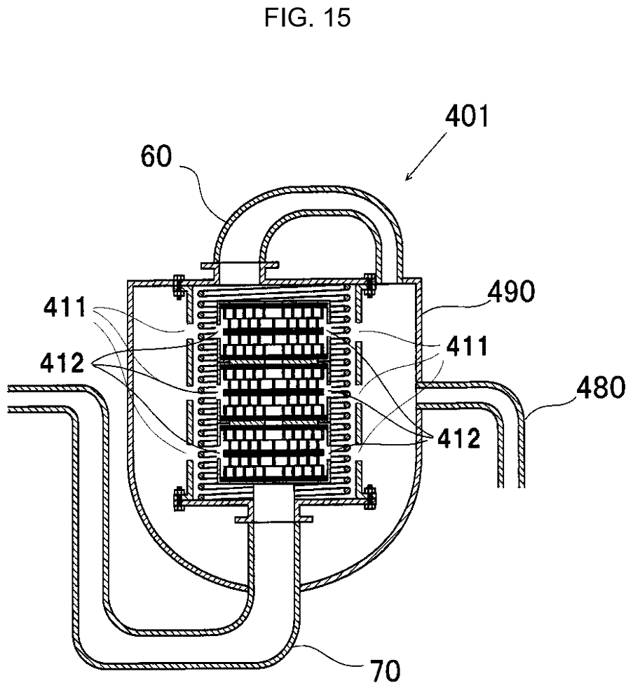

FIG. 15 is a cross-sectional view illustrating a liquefaction enhancement device 401, or the stationary liquefaction enhancement device that uses a spring, and additionally, an outer tank. Namely, it is the liquefaction enhancement device 301 with an outer tank 490. The outer tank 490 is similar to the outer tank 90 (FIG. 6). This configuration suppresses heat generation in the liquefaction enhancement device, which improves the heat exchange efficiency, and leads to energy reduction.

In this embodiment, too, a plurality of apertures 412 can be provided in the side walls of the cylindrical casing that encases the flow-guiding units to regulate the fluid pressure within an appropriate range. Apertures 411 can also be provided in the side walls of a part of the casing where the spring is located to regulate the fluid pressure within an appropriate range.

### Embodiment of Stationary Liquefaction Enhancement Device With Outer Tank, With Spring Applied to Outer Tank

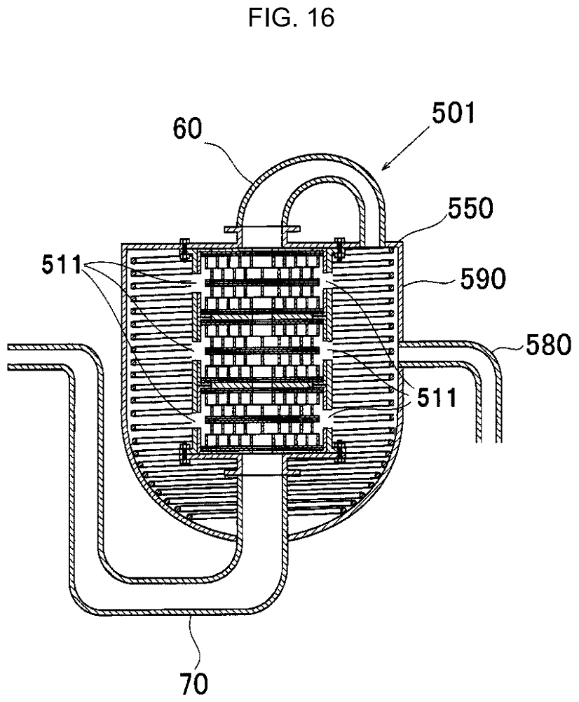

FIG. 16 is a cross-sectional view illustrating a liquefaction enhancement device 501, or the stationary liquefaction enhancement device having an outer tank, with a spring 550 applied to the outer tank 590. Namely, this embodiment uses the spring 550 in the outer tank of the embodiment shown in FIG. 6. The spring 550 depicted in FIG. 16 is tapered, with its diameter reducing downward. The tapered spring can also be applied to other embodiments shown in FIG. 13, FIG. 14, and FIG. 15. The tapered spring is expected to cause additional changes in the fluid flows, thereby increasing the shear effects. The spring 550 provides the pulsation suppression and the shear effects, in addition to the shear effects achieved by passing the fluids through the flow-guiding units. This improves the heat exchange rate and leads to energy reduction.

In this embodiment, too, a plurality of apertures 511 can be provided in the side walls of the cylindrical casing that encases the flow-guiding units to regulate the fluid pressure within an appropriate range.

### Embodiment of Rotary Liquefaction Enhancement Device With Spring

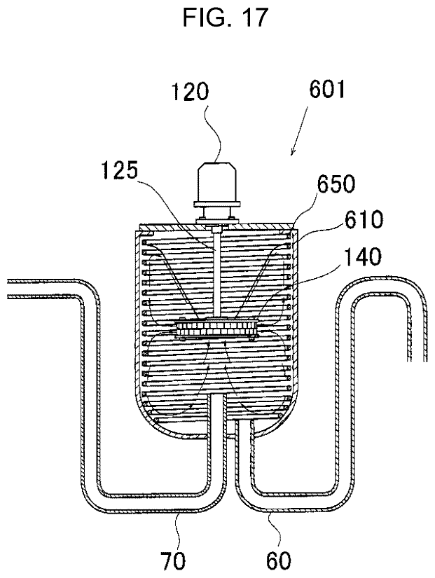

FIG. 17 is a cross-sectional view illustrating a liquefaction enhancement device 601, or the rotary liquefaction enhancement device shown in FIG. 7, with a spring used inside the agitation tank. The spring 650 is set inside the agitation tank 610 such as to be vibrate freely. The shear effects achieved by the high-speed rotation of the rotary mixing member 140 driven by the rotary drive source 120, combined with the pulsation suppression and the shear effects provided by the spring 650, improve the heat exchange rate and reduce energy.

### Embodiment of Rotary Liquefaction Enhancement Device With Spring in Agitation Tank, and Outer Tank

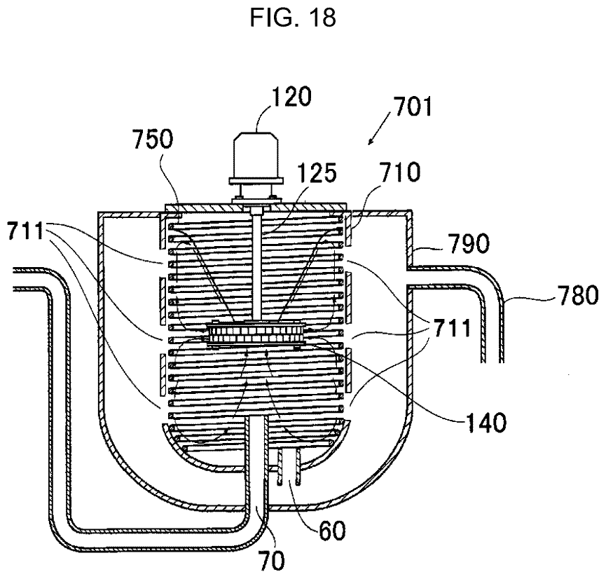

FIG. 18 is a cross-sectional view illustrating a liquefaction enhancement device 701, or the liquefaction enhancement device 601 shown in FIG. 17 with an additional surrounding outer tank 790. The shear effects achieved by the high-speed rotation of the rotary mixing member 140 driven by the rotary drive source 120, combined with the pulsation suppression and the shear effects provided by the spring 750, improve the heat exchange rate and reduce energy.

In this embodiment, a plurality of apertures 711 can be provided in the side walls of the agitation tank to regulate the fluid pressure within an appropriate range.

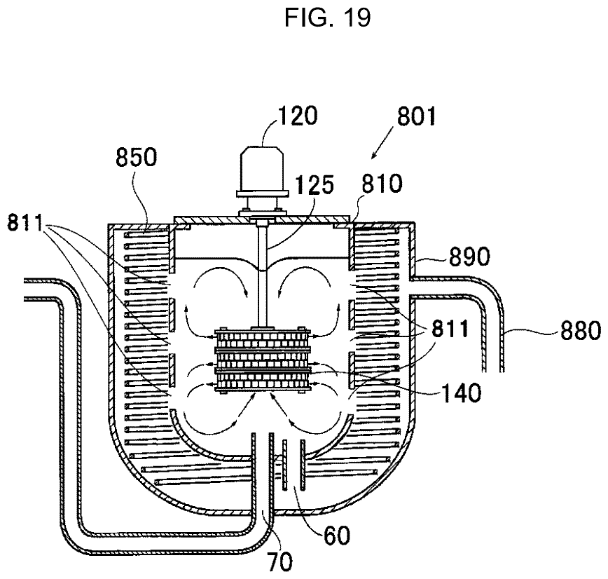

FIG. 19 is a cross-sectional view illustrating an embodiment with a spring provided to the outer tank of the rotary liquefaction enhancement device. The shear effects achieved by the high-speed rotation of the rotary mixing member 140 driven by the rotary drive source 120, combined with the pulsation suppression and the shear effects provided by the spring 850 in the outer tank 890, improve the heat exchange rate and reduce energy.

In this embodiment, a plurality of apertures can be provided in the side walls of the agitation tank 810 to regulate the fluid pressure within an appropriate range.

### Power Reduction Performance

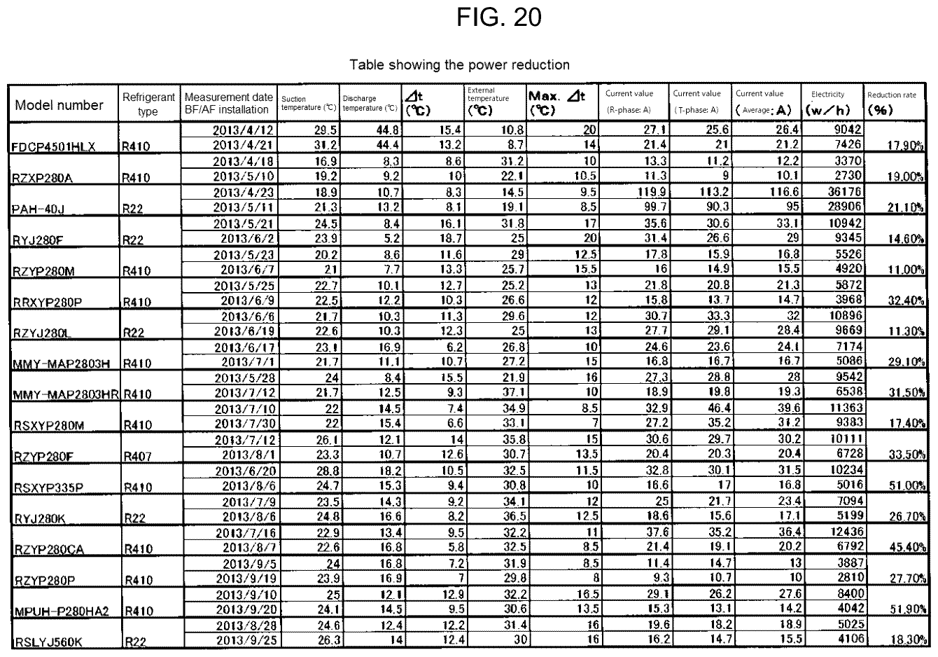

FIG. 20 is a table showing the power reduction performance of the liquefaction enhancement device shown as Embodiment 6. The “machine model number” in the table refers to the model numbers of heat pump systems. “Refrigerant type” indicates the types of refrigerant such as R410 and R22. “Measurement date before installation” and “measurement date after installation” indicate that measurements were made before and after the date on which the liquefaction enhancement device 301 (Embodiment 6) according to the present invention was retrofitted to an existing heat pump system. “Suction temperature” and “discharge temperature” refer to the temperatures on the suction side and the discharge side of air conditioners, respectively. “At” indicates the difference between the suction temperature and the discharge temperature. “Exterior temperature” is the outdoor temperature. “Max. At” indicates an instantaneously observed maximum temperature difference. Three types of current values were obtained: R-phase, T-phase, and mean value. The amount of electricity is expressed in watt-hours. The reduction rate is expressed as the percentage of power consumption after installation compared to before installation.

As can be seen from FIG. 20, the power reduction rate was reduced by at least 11% and as much as 51.9%.

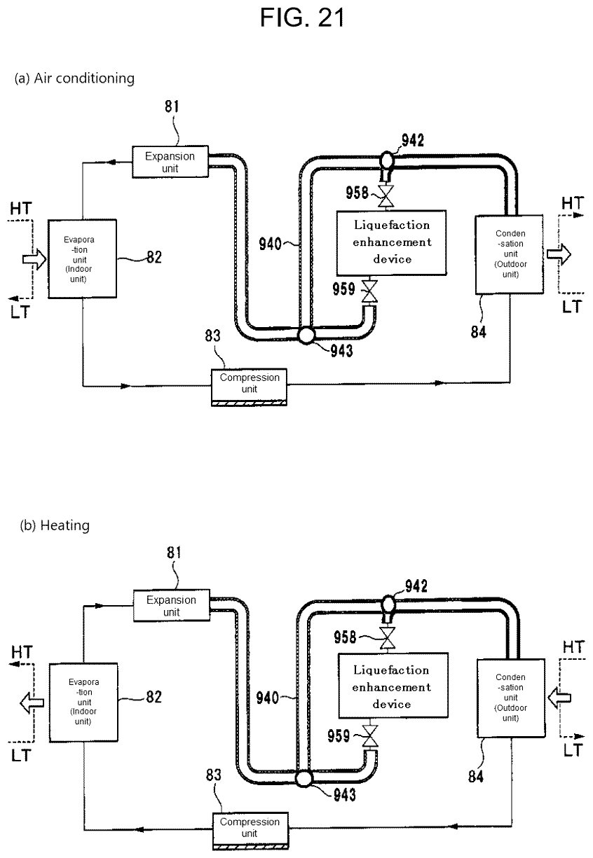

As shown in FIG. 21, further variations are possible in the above-described embodiments with an outer tank. Valves 958 and 959 are provided to the pipe where the outer tank is connected to a heat pump system to allow closure. This enables the system to be delivered to a site with the necessary amount of refrigerant already sealed in the outer tank of the liquefaction enhancement device. The outer tank is relatively large and is configured as a pressure vessel, or a sealed vessel, or an airtight vessel. The amount of refrigerant gas required for individual heat pump systems can be calculated in advance. With the necessary amount of refrigerant gas already filled in the outer tank of the liquefaction enhancement device according to the present invention before shipment, there is no need to measure and inject the refrigerant gas on site. The liquefaction enhancement device can also be used in this way, i.e., serving as a refrigerant gas vessel that is already filled with the necessary amount of refrigerant gas for individual heat pump systems. In this case, a bypass 940 is provided to the heat pump system, with 3-way directional valves 942 and 943 on both ends of the bypass 940. This allows the liquefaction enhancement device according to the present invention to be installed in an existing heat pump system, by connecting the above-mentioned valves 958 and 959 to these 3-way directional valves 942 and 943, respectively. Any of the stationary liquefaction enhancement devices and rotary liquefaction enhancement devices described herein, in particular, those with an outer tank, can be used as this embodiment of the “liquefaction enhancement device.”

The device according to the present invention is widely applicable to any heat pump that performs heat exchange and circulates a refrigerant oil and a refrigerant oil, regardless of whether it uses electricity or gas as the energy source.

### REFERENCE SIGNS LIST

1 Liquefaction enhancement device (stationary liquefaction enhancement device)
10 Casing
11 Aperture
21,22, 23 Flow-guiding unit
31, 32, 33, 34, 35, 36 Large-diameter disc
41, 42, 43, 44, 45, 46 Small-diameter disc
50 Cell
60 Inlet (in cooling mode, outlet in heating mode)
70 Outlet (in cooling mode, inlet in heating mode)
81 Expansion unit
82 Evaporation unit (indoor unit)
83 Compression unit
84 Condensation unit (outdoor unit)
90 Outer tank
101 Rotary liquefaction enhancement device
110 Agitation tank
111 Aperture
120 Rotary drive source
125 Rotation shaft
130, 140 Rotary mixing member
131 Upper disc
132 Lower disc
190 Outer tank
201 Liquefaction enhancement device (with spring)
210 Cylindrical casing
211 Aperture
220 Upper casing
230 Lower casing
250 Spring
301 Stationary liquefaction enhancement device (with spring)
310 Cylindrical casing
320 Upper casing
330 Lower casing
350 Spring
401 Stationary liquefaction enhancement device (with spring and outer tank)
411,412 Aperture
480 Outer tank piping
490 Outer tank
501 Stationary liquefaction enhancement device (with spring-equipped outer tank)
51 Aperture
550 Spring
580 Outer tank piping
590 Outer tank
601 Rotary liquefaction enhancement device (with spring-equipped agitation tank)
610 Agitation tank
650 Spring
701 Rotary liquefaction enhancement device (with spring-equipped agitation tank and outer tank)
710 Agitation tank
711 Aperture
750 Spring
780 Outer tank piping
790 Outer tank
801 Rotary liquefaction enhancement device (with spring-equipped outer tank)
810 Agitation tank
811 Aperture
850 Spring
880 Outer tank piping
890 Outer tank
940 Bypass
942, 943 3-way directional valve
958,959 Valve

1. A stationary liquefaction enhancement device comprising:
a cylindrical inner tank including an inner-tank outlet at one end and an inner-tank inlet at the other, and a side wall formed with a plurality of apertures;
a flow-guiding unit installed inside the inner tank, including concentrically stacked large-diameter discs and small-diameter discs each formed with a honeycomb-like array of numerous open polygonal cells on one side facing each other, the large-diameter discs being adjacent each other and the small-diameter discs being adjacent each other;
an outer tank surrounding the cylindrical inner tank;
an outer-tank inlet of the outer tank; and
an outer-tank outlet of the outer tank,
the stationary liquefaction enhancement device being installed in a line of piping of a heat pump system by connecting the outer-tank inlet and the outer-tank outlet to the piping for agitating fluids including a refrigerant and a refrigerant oil of the heat pump system,
the large-diameter discs having a diameter matching an inside diameter of the inner tank and formed with a communication hole in a center area,
the large-diameter discs and the small-diameter discs being staggered such that their respective cells positioned opposite each other communicate with each other,
the large-diameter discs of the flow-guiding unit being positioned at both ends of the cylindrical inner tank, with the communication holes being communicated with
the fluids including the refrigerant and the refrigerant oil being passed through both the inner tank and the outer tank of the stationary liquefaction enhancement device at pressures ranging from 0.2 to 10 megapascals during an operation of the heat pump system, and circulated repeatedly through a cycle of the heat pump system, thereby being agitated and mixed evenly.

2. A rotary liquefaction enhancement device comprising:
an agitation tank including an agitation-tank outlet, an agitation-tank inlet, and a side wall formed with a plurality of apertures;
a rotation shaft provided inside the agitation tank;
a rotary drive source configured to rotate the rotation shaft;
a rotary mixing member attached to the rotation shaft and configured to agitate fluids inside the agitation tank;
an outer tank surrounding the agitation tank;
an outer-tank inlet of the outer tank; and
an outer-tank outlet of the outer tank,
the rotary liquefaction enhancement device being installed in a line of piping of a heat pump system by connecting the outer-tank inlet and the outer-tank outlet to the piping for agitating fluids including a refrigerant and a refrigerant oil in a heat pump cycle of the heat pump system to enhance liquefaction,
the rotary mixing member including a pair of an upper disc and a lower disc stacked upon one another, the lower disc having an inlet port in a center area, the upper disc and the lower disc each being formed with an array of numerous tubular cells on their front side facing each other and open toward each other,
the cells of the upper disc and the cells of the lower disc opposite each other communicating with other,
the arrays of cells being offset so that an intersecting joint portion of a side wall that forms a cell of one disc is located at the center of a cell of the other disc,
the fluids including the refrigerant and the refrigerant oil being passed through both the agitation tank and the outer tank at pressures ranging from 0.2 to 10 megapascals during an operation of the heat pump system, and circulated repeatedly through the cycle of the heat pump system, thereby being agitated and mixed evenly.

3. The stationary liquefaction enhancement device according to claim 1, further comprising a spring provided inside the outer tank, the spring having an outer shape smaller than an inside diameter of the outer tank so as to allow free vibration of the spring.

4. The rotary liquefaction enhancement device according to claim 2, further comprising a spring provided inside the agitation tank, the spring having an outer shape smaller than an inside diameter of the agitation tank so as to allow free vibration of the spring.

5. The rotary liquefaction enhancement device according to claim 2, further comprising a spring provided inside the outer tank, the spring having an outer shape smaller than an inside diameter of the outer tank so as to allow free vibration of the spring.
